(19) United States
(12) Patent Application Publication
(10) Pub. No.: US 2008/0268955 A1
(43) Pub. Date: Oct. 30, 2008

(54) Game Playing Methods and Apparatus

(75) Inventor: Mark Charles Spittle, Glamorgan (GB)

Correspondence Address: EDWIN D. SCHINDLER, FIVE HIRSCH AVENUE, P.O. BOX 966, CORAM, NY, 11727-0966, US

(73) Assignee: FFYNNON GAMES LIMITED, Cardiff (GB)

(21) Appl. No.: 11/814,164

(22) PCT Filed: Jan. 17, 2006
(86) PCT No.: PCT/GB06/50009

§ 371 Date: Jul. 17, 2007

(30) Foreign Application Priority Data
Jan. 17, 2005 (GB) 0500950.1
Jan. 20, 2005 (GB) 0501256.2
Feb. 1, 2005 (GB) 0502034.2
Jul. 18, 2005 (GB) 0514672.5

(51) Int. Cl. G06F 17/00

(52) U.S. Cl. 463/37

(57) ABSTRACT

A game-playing apparatus includes a device for playing an optical data-storage disc, an optical data-storage disc authored to provide an interactive game and, at least, two handsets for remotely controlling the operation of the playing device to play the game.

The present invention relates to a game-playing apparatus and, more particularly to an electronic apparatus for providing an interactive game.

A number of so called “interactive DVD games” have recently been devised, in which a plurality of players compete against one-another to answer questions and/or solve puzzles presented to them as clips selected at random from a plurality of clips stored on a DVD optical data-storage disc.

At least one of the games presently available requires players to compete to answer the same question simultaneously (i.e. the ALL PLAY feature of the SceneIt™ DVD-based board game produced by Screenlife™). However, the apparatus used to play that particular game, i.e. a conventional remote-controlled DVD player and TV combination, fails to provide any means for identifying either the first person to answer or attempt to answer the question or those multiple persons who correctly answer the question; game-players are merely required to shout-out their respective answers and then decide amongst themselves who, if any of them, was the first to provide the correct answer.

Such a game-playing apparatus is therefore limited in the extent to which it may be used to implement many popular game formats, such as those of a number of well known TV quiz-show games, in which such identification means are essential.

I have now devised an arrangement which overcomes the limitations of existing game playing apparatus.

According to a first aspect of the present invention, there is provided a game-playing apparatus comprising a device for playing an optical data-storage disc, an optical data-storage disc authored to provide an interactive game and at least two handsets for remotely controlling the operation of the playing device to play the game.

It will be appreciated that use of such an apparatus provides a means by which two or more game-players may, substantially simultaneously, transmit respective control signals to a playing device (which would typically comprise a DVD player), so that the order of play of content items stored on the optical data-storage disc (which would typically comprise a DVD, VCD or SVCD) may be controlled, for example, according to the order in which the control signals are received from the players' respective handsets or according to whether the received signals are indicative of correct/incorrect responses to a particular prompt.

Preferably said at least two handsets are arranged to transmit control signals to said playing device via respective infra-red transmitters, but may instead be arranged to transmit control signals via a single infra-red transmitter or via at least one radio-frequency, ultrasonic or other transmitter.

Preferably at least one of said at least one handsets is reconfigurable to associate a desired infra-red control signal (or sequence of control signals) with at least one operating button thereof. Thus, a “game-playing” handset may be configured for use in addition to or in place of the dedicated remote-control handset normally used to control the operation of the playing device, the game-playing handset having only those buttons required to play a particular game, arranged in a convenient fashion.

Said at least one handset may be arranged to be reconfigured by entering appropriate re-configuration instructions either manually, via at least one operating button of the handset, or via a connecting interface/port of the handset. However, most preferably, said at least one handset comprises an infra-red receiver and is arranged to be reconfigured by receiving, via said infra-red receiver, the control signal to be associated with said at least on operating button, from another handset, such as the dedicated remote-control handset normally used to control the operation of the playing device.

Preferably said at least two handsets are reconfigurable to associate different infra-red control signals with at least one corresponding operating button thereof, so that the handsets will each transmit a different respective control signal when the same operating button of each is pressed. In this case, one or more of said at least two handsets preferably comprises means for switching the connectivity of said plurality of buttons between a set-up connectivity arrangement, wherein the corresponding buttons of the handsets are associated with the same control signals, and a normal operating connectivity arrangement, wherein different control signals are associated with corresponding buttons.

Preferably the disc is authored such that game-players are identified from the control signals transmitted by their respective handsets.

Thus, the apparatus may be used to play a variety of hitherto unrealisable, interactive multi-player games.

For example, in a first embodiment, the disc may be authored such that a plurality of game-players are each prompted for a response, the first person thereafter to press a particular button on his or her handset being identified, e.g. as the person to whom the opportunity is to be given to provide a verbal or interactive response to the question.

In a slightly more elaborate embodiment, the disc may instead be authored such that a plurality of game-players are each required to provide one of a plurality of possible responses to a prompt, each corresponding to a different button on each of the game-players' handsets, the first or each game-player to provide the required response (by pressing the appropriate button on his or her handset) being identified, e.g. as a person whose score is to be incremented in a general purpose (GPRM) DVD register.

The functionality of each of the aforementioned embodiments and of further possible embodiments may be implemented by configuring two or more handsets such that different menu-navigation buttons are mimicked by corresponding buttons of those handsets and authoring the disc such that players are presented with a menu having respective on-screen menu-buttons arranged to be selected by the pressing of each of said corresponding handset buttons, and such that a respective action associated with each of the menu-buttons is automatically invoked (i.e. without a second, confirmatory signal having to be transmitted from a handset), either immediately upon that button being selected or after a pre-determined period of time.

The action associated with each of the menu-buttons of the menu may, for example, be to modify the value(s) stored in one or more registers or to display a further menu.

Thus, mimicking the control signals associated with the four menu-navigation buttons (up, down, left and right) normally provided on a handset for controlling a DVD player, would allow two players to compete against one another by simultaneously selecting between two possible answers or for up to four players to compete with one another for the opportunity to answer a question.

The action associated with each of the menu-buttons of the first menu may be to display a second respective menu, having menu-buttons arranged to be selected by pressing only the buttons of the handset used by a player other than the first player to operate his handset.

Preferably the first and second menus are identical (so that players are unaware of the transition between the two) with the second menu preferably being configured to invoke the display of a prompt should the operation of only one handset button be registered within a pre-determined period of time, as might arise either as a result of a player neglecting to press a button of his/her handset or if both players operate their respective handsets before the resulting transition to the second menu is complete (the inventor having found a delay of up to 0.5 seconds to be commonplace when switching between DVD menus in the substantially “instantaneous” manner described above).

Alternatively, and more preferably, each of the “auto-action” menu-buttons may be selected via a transition through at least one other menu button, preferably such that the order in which the players press the operating buttons of their respective handsets determines which auto-action menu-button is selected.

The action associated with each of the “auto-action” menu-buttons may also or otherwise be to modify the value(s) stored in one or more registers, for example by incrementing a register before automatically transitioning to a further button or according to whichever button might be selected after a pre-determined period of time (e.g. upon a menu time-out).

It will be appreciated that either of latter 2 arrangements will allow corresponding actions to be taken according to which players are correct in their respective responses, for example to award a point to each player to provide a correct response and/or a (further) point to the first player to correctly respond to a prompt.

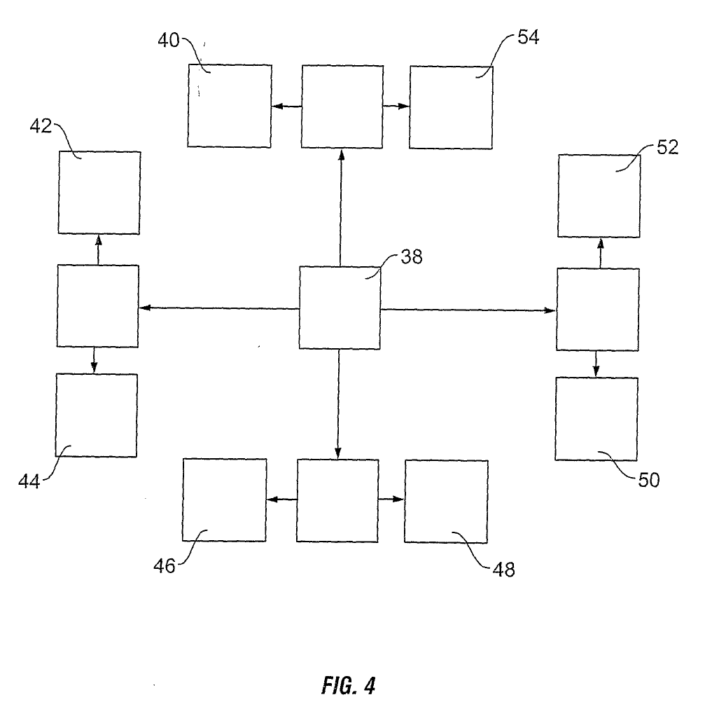

For example the menu may conveniently comprise an array of menu-buttons, arranged as shown in FIG. 4 (or interconnected to provide the same effect), the central button being selected by default.

Say to correctly answer a question Player A is required to press a button on his handset to produce an “up” signal (as opposed to a “down” signal that would be produced by pressing a second button) and Player B is required to press a button on his handset to produce an “left” signal (as opposed to a “right” signal that would be produced by pressing a second button), then the value stored in SPRM 8, upon a timeout of the menu, or a unique command associated with that button would provide an indication of which player(s) had answered correctly and the order in which correct answers were submitted.

It should be noted that many DVD players permit on-screen menu-buttons to be selected by pressing respective numbered buttons of their remote-control handsets and therefore the term “menu-navigation” button, in the present context, may be construed to include both the “up”, “down”, “left” and “right” buttons, as well as the numbered buttons found on most conventional DVD remote-control handsets.

It should also be noted that whilst the apparatus comprises at least two handsets for remotely controlling the operation of the playing device to play the interactive game, the game may comprise portions that require the use of only a single handset.

According to a second aspect of the present invention, there is provided a method for authoring an optical data-storage disc, wherein the disc is authored to provide an interactive game, playable by at least two game-players via respective handsets arranged to transmit respective control signals to a device on which the disc is played.

According to a third aspect of the present invention, there is provided software for authoring an optical data-storage disc to provide an interactive game, playable by at least two game-players via respective handsets arranged to transmit respective control signals to a device on which the disc is played.

According to a fourth aspect of the present invention, there is provided an optical data-storage disc authored to provide an interactive game, playable by at least two game-players via respective handsets arranged to transmit respective control signals to a device on which the disc is played.

According to a fifth aspect of the present invention, there is provided a method for configuring an apparatus for use in playing a game, the method comprising the steps of:

providing an optical data-storage disc authored to provide an interactive game;

providing a device for playing the optical data-storage disc;
providing substantially identical first and second remote control handsets, each handset being reconfigurable to associate a desired control signal (or sequence of control signals) with at least one operating button thereof; and
configuring the first and second handsets such that a different control signal (or sequence of control signals) is associated with a control button of the first handset than that (or those) associated with the same operating button of the second handset.

According to a sixth aspect of the present invention, there is provided a kit comprising at least two handsets for remotely operating a DVD player to play an interactive game, each handset being reconfigurable to associate a desired control signal (or sequence of control signals) with at least one operating button thereof.

According to a seventh aspect of the present invention, there is provided a method for controlling the order in which clips, e.g. audio and/or still image and/or moving image clips, are accessed by a playing device from a number of clips stored on an optical data-storage disc, wherein respective operating signals are transmitted to the playing device from at least two remote-control handsets.

According to an eighth aspect of the present invention, there is provided an apparatus comprising a device for playing an optical data-storage disc, an optical data-storage disc and a reconfigurable handset for remotely controlling the operation of the playing device, the optical data storage disc being authored such that the control function normally associated with the control signal (or sequence of control signals) assigned to at least one operating button of the handset is modified.

For example, the disc may be authored such that the control signal assigned to a particular button of the handset, the transmission of which would normally cause the playing device to skip forwards/backwards one clip, will instead cause the playing device to skip to a pre-determined clip, not necessarily the one directly following/preceding the present clip. Thus, the optical data-storage disc may be authored to provide a quiz, in which a player is prompted to press a control button of his handset when he feels he is able to provide an answer to a question (perhaps thereby stopping or pausing a countdown timer), the player's action having an immediate effect (i.e. the player is not required to manipulate navigation buttons to operate a conventional DVD control menu interface, to respond to a prompt).

Preferably the optical data-storage disc is authored to provide a quiz and such that an appropriate sequence of operation of the playing device is followed, according to whether the control signal (or sequence of control signals) received from the remote control handset, in response to a user pressing said particular button, is indicative of a correct/incorrect response to a particular prompt.

According to a ninth aspect of the present invention, there is provided a method for authoring an optical data-storage disc, wherein the disc is authored such that the control function normally associated with the control signal (or sequence of control signals) assigned to at least one operating button of a remote-control handset used to control a device for playing said optical data-storage disc is modified.

According to a tenth aspect of the present invention, there is provided software for authoring an optical data-storage disc, such that the control function normally associated with the control signal (or sequence of control signals) assigned to at least one operating button of a remote-control handset used to control a device for playing said optical data-storage disc is modified.

According to an eleventh aspect of the present invention, there is provided an optical data-storage disc, authored such that the control function normally associated with the control signal (or sequence of control signals) assigned to at least one operating button of a remote-control handset used to control a device for playing said optical data-storage disc is modified.

According to a twelfth aspect of the present invention, there is provided a method for configuring an apparatus, the method comprising the steps of:

providing a device for playing an optical data-storage disc;

providing a remote control handset, reconfigurable to assign a desired control signal (or sequence of control signals) to at least one operating button thereof, for operating said playing device;

assigning a particular control signal (or sequence of control signals) to said at least one operating button; and

providing an optical data-storage disc authored such that the control function normally associated with the control signal (or sequence of control signals) assigned to said at least one operating button is modified.

According to a thirteenth aspect of the present invention, there is provided a method for controlling the order in which clips, e.g. audio and/or still image and/or moving image clips, are accessed by a playing device from a number of clips stored on an optical data-storage disc, by transmitting a control signal (or sequence of control signals) from a remote control handset, wherein the optical data-storage disc is authored such that the control function normally associated with the control signal (or sequence of control signals) is modified.

According to a fourteenth aspect of the present invention, there is provided an apparatus comprising a device for playing an optical data-storage disc, an optical data-storage disc and a handset for remotely controlling the operation of the playing device, the disc being authored such that a user is presented with a menu having at least one on-screen menu-button arranged to be selected by transmitting a respective menu-navigation control signal from said handset and such that a respective action associated with the or each menu-button is automatically invoked (i.e. without a second, confirmatory signal being having to be transmitted from the handset).

The respective action associated with the or each menu-button may either be invoked immediately, upon that button being selected, or after a pre-determined period of time.

Thus, for example, by using the up, down, left and right menu-navigation buttons normally provided on a handset for controlling a DVD player (or the buttons of a reconfigurable handset, configured to mimic one or more of those menu-navigation buttons), a player may select from between up to four possible answers to a question in a quiz game.

Said menu-navigation control signal may comprise one of a sequence of menu-navigations control signals transmitted from 2 or more handsets.

Preferably the menu-buttons of the menu are hidden from the player.

According to a fifteenth aspect of the present invention, there is provided a method for authoring an optical data-storage disc, wherein the disc is authored such that a user is presented with a menu having at least one menu-button arranged to be selected by transmitting a respective menu-navigation control signal from a remote-control handset and such that a respective action associated with the or each menu-button is automatically invoked.

According to a sixteenth aspect of the present invention, there is provided software for authoring an optical data-storage disc, such that a user is presented with a menu having at least one menu-button arranged to be selected by transmitting a respective menu-navigation control signal from a remote-control handset and such that a respective action associated with the or each menu-button is automatically.

According to a seventeenth aspect of the present invention, there is provided an optical data-storage disc, authored such that a user is presented with a menu having at least one menu-button arranged to be selected by transmitting a respective menu-navigation control signal from a remote-control handset and such that a respective action associated with the or each menu-button is automatically invoked.

According to an eighteenth aspect of the present invention, there is provided a method for configuring an apparatus, the method comprising the steps of:

providing a device for playing an optical data-storage disc;

providing a remote control handset, reconfigurable to assign a menu-navigation control signal to at least one operating button thereof, for operating said playing device;

assigning a particular menu-navigation control signal to said at least one operating button; and

providing an optical data-storage disc authored such that a user is presented with a menu having at least one menu-button arranged to be selected by transmitting said menu-navigation control signal(s) from said handset and such that a respective action associated with the or each menu-button is automatically invoked.

According to a nineteenth aspect of the present invention, there is provided a method for controlling the order in which clips, e.g. audio and/or still image and/or moving image clips, are accessed by a playing device from a number of clips stored on an optical data-storage disc, by transmitting a menu-navigation control signal from a remote control handset, wherein the optical data-storage disc is authored such that a user is presented with a menu having at least one menu-button arranged to be selected by transmitting said menu-navigation control signal from said remote-control handset and such that a respective action associated with the or each menu-button is automatically invoked.

Embodiments of the present invention will now be described by way of examples only and with reference to the accompanying drawings, in which:

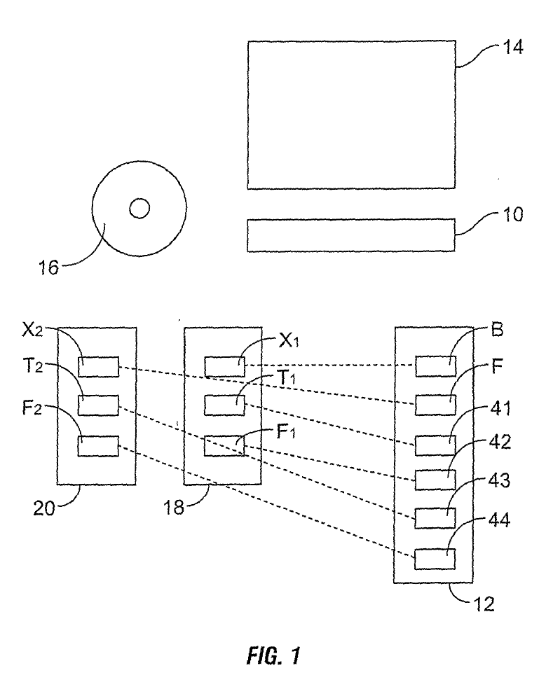

FIG. 1 is a schematic diagram of a game playing apparatus in accordance with the present invention;

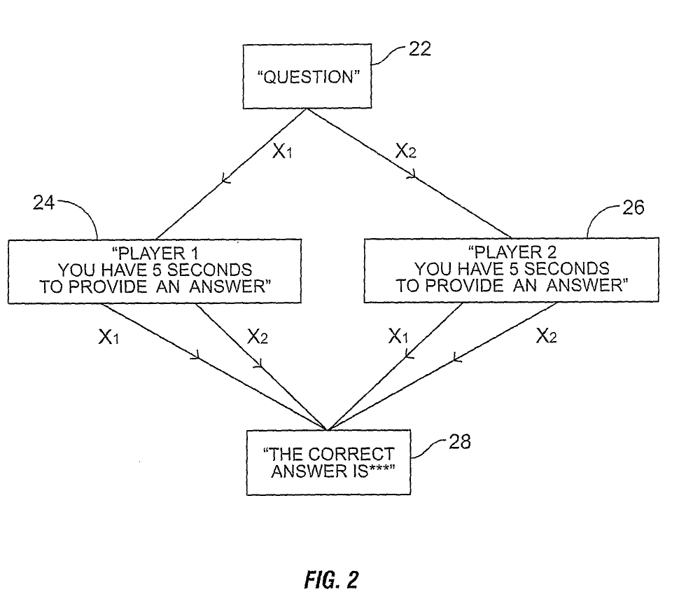

FIG. 2 is a flow diagram illustrating a first mode of operation of the apparatus of FIG. 1;

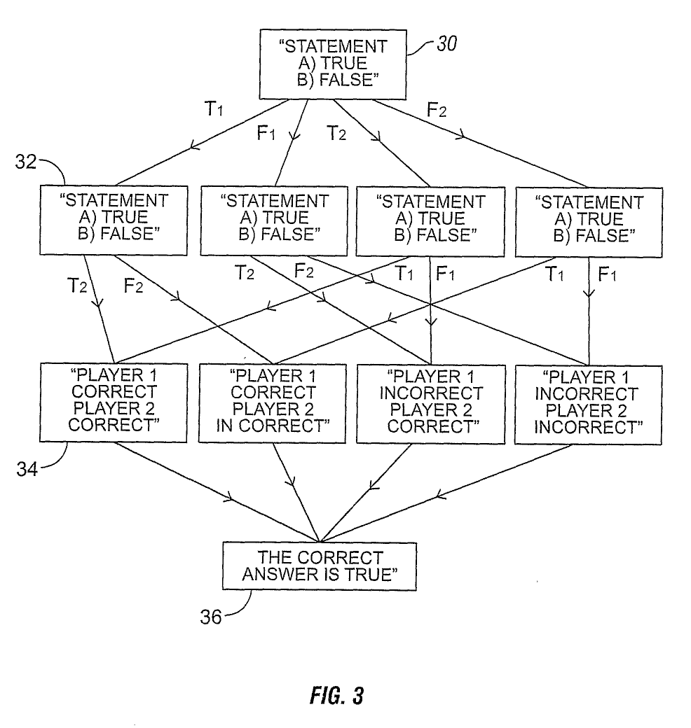

FIG. 3 is a flow diagram illustrating a second mode of operation of the apparatus of FIG. 1; and

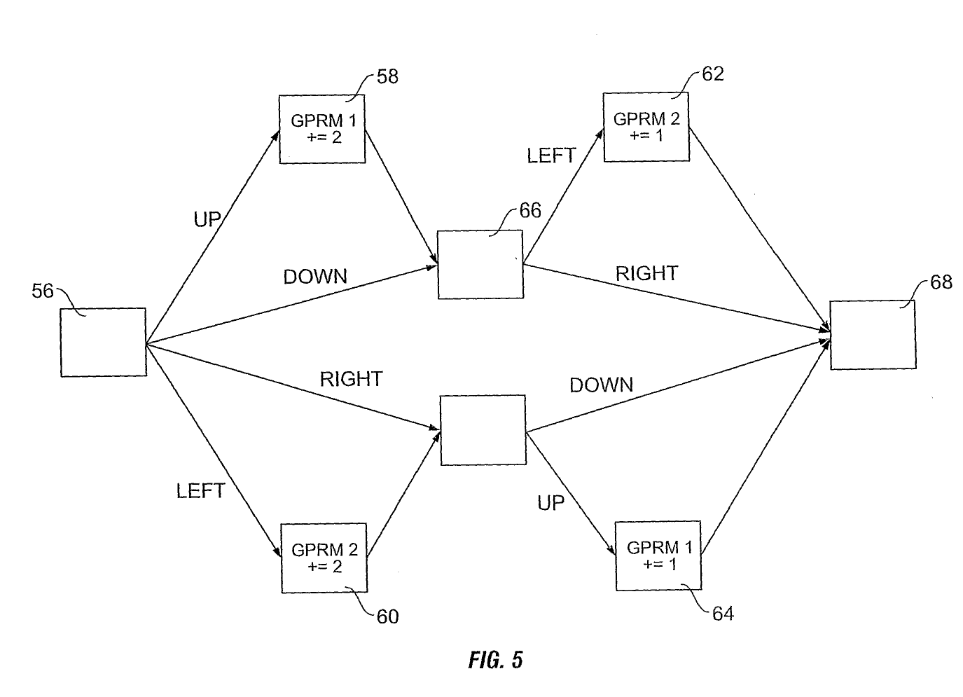

FIGS. 4 and 5 are respective menus for implementing equivalent modes of operation to that of FIG. 3.

Referring to FIG. 1, a game-playing apparatus is shown comprising a DVD player 10, a dedicated (i.e. non-programmable) remote-control handset 12 normally used for remotely controlling the operation of the DVD player, a television-set 14 to which the DVD player 10 is connected, a DVD optical data-storage disc 16 authored to provide an interactive game when played on the DVD player 10 and a further, substantially identical pair 18,20 of remote-control handsets, each reconfigurable to remotely control the operation of the DVD player 10 to play the game.

Prior to playing the DVD disc 16 on the player, the two reconfigurable handsets 18,20 must first be configured to transmit appropriate control signals to the DVD player 10 to control its operation; this is achieved by copying respective control signals from the dedicated remote-control handset 12 normally used to control the DVD player 10, to each of the reconfigurable handsets 18,20, in turn, for subsequent reproduction by those handsets when appropriate buttons X1,X2 thereof are pressed.

As a first example, the DVD 16 may be authored to provide a game wherein a question is presented via the television-set 14 and so that the reception of specific first and second coded infra-red signals by the DVD player 10 are treated as responses from first and second game-players respectively.

In this case, the first and second coded infra-red signals are chosen to be those that would be transmitted by the dedicated remote-control handset 12 normally used to control the operation of the DVD player 10, were a certain two respective buttons of that handset to be pressed. If, for example, the coded infra-red signals are chosen to be those associated with the two buttons B,F ordinarily used to skip backwards and forwards through a DVD feature, the two reconfigurable handsets 18,20 are configured by transmitting to each, a respective one of the chosen codes, that code being reproduced by the configured handset when a particular button of the handset X1,X2 is subsequently pressed.

As a second, more elaborate example, the DVD 16 may be authored to provide a game wherein a question is presented via the television-set 14, along with a plurality of possible answers to that question, and so that the reception of specific coded infra-red signals by the DVD player 10 are treated as answer selections by first and second players respectively.

In this case, the specific coded infra-red signals are similarly chosen to be those that would be transmitted by the dedicated remote-control handset 12 normally used to control the operation of the DVD player 10, were certain respective buttons of that handset to be pressed (such as the buttons normally used to navigate a menu). If, for example, the game-players are presented with two possible answers: A) TRUE and B) FALSE, and the coded infra-red signals are chosen to be those associated with the four menu-navigation buttons “up”, “down”, “left” and “right” of the remote-control handset 12 normally used to control the operation of the DVD player 10, the two reconfigurable handsets 18,20 would be configured by transmitting to each, a respective set of two of the chosen codes, each of those two codes being reproduced by the thus configured handset when corresponding buttons T1,F1,T2,F2 thereof are subsequently pressed.

FIG. 2 illustrates, schematically, a preferred configuration of DVD content for implementing the first mode of operation of the apparatus of FIG. 1 described above, wherein a still image showing a question is first displayed 22.

Then, if the coded signal associated with the “skip-backwards” button B of the handset 12 normally used to control the DVD player 10 is received from the first reconfigurable handset 18 (in response to an appropriate button X1 of the first reconfigurable handset 18 being pressed) then an image is displayed identifying Player 1 as that player to whom the opportunity is to be given to answer the question 24.

If the coded signal associated with the “skip-forwards” button F of the handset 12 normally used to control the DVD player 10 is instead received from the second reconfigurable handset 20 (in response to the same button X2 of the second reconfigurable handset 20 being pressed as that button X1 of the first handset 18 which is associated with the “skip-backwards” signal) an image is displayed identifying Player 2 as that player to whom the opportunity is to be given to answer the question 26.

In either case, after a predetermined period of time, the display changes automatically to one asking for confirmation whether the answer to the question is to be revealed. Thus, if a player is unable to provide an answer to the question within said pre-determined period of time, his opponent may be permitted to attempt to answer the question, before one or other player transmits a control signal to the DVD player 10 to change the display to one which reveals the correct answer to the question 28.

FIG. 3 illustrates, schematically, a first preferred configuration of DVD content for implementing the second mode of operation of the apparatus of FIG. 1 described above, wherein a still image showing a question and two possible answers: A) TRUE and B) FALSE is first displayed 30.

Then, if the coded signal associated with the button menu-navigation “up” button 41 of the handset 12 normally used to control the DVD player 10 is received from the first reconfigurable handset 18 (in response to an appropriate button T1 of the first reconfigurable handset 18 being pressed), then that response is deemed to constitute a TRUE answer from Player 1 and the question is re-displayed awaiting a response from Player 2 32.

If the signal associated with the menu-navigation “down” button 42 is instead received from the first reconfigurable handset 18, then that response is deemed to constitute a FALSE answer from Player 1.

Similarly, a “left” or a “right” signal (associated with buttons 43 and 44 of handset 12) received from the second reconfigurable handset 20 is deemed to constitute a TRUE or FALSE answer from Player 2 respectively.

It should be noted that, in some cases, the transmission of a control signal associated with a button of a remote-control handset may require that signal to be followed by the confirmatory control signal associated with an “enter/OK” button, for a corresponding function to be invoked. Therefore, each of the reconfigurable handsets may be reconfigurable to associate a so-called macro function with one or more of its respective operating buttons, so that the operation of the or each “macro” button results in the transmission of a pre-determined sequence of control signals.

Once respective responses have been provided by each of the two players, the display then changes according to whether either or both of the players has provided a correct or an incorrect response to the question 34, before proceeding to reveal what was indeed the correct response 36. However, if a response is received from only one player, the other player may be prompted to provide a response.

In this case, the DVD may be authored such that a score is maintained for each player, which is incremented and/or decremented according to whether the player's response is correct or incorrect and/or whether a player is the first or the second to provide a correct response.

As an alternative to the configuration of FIG. 3, for implementing the second mode of operation of the apparatus of FIG. 1, each question may be presented as a menu comprising a plurality of hidden menu buttons, arranged either as shown in FIG. 4 or as shown in FIG. 5 (or arranged and linked to provide the same effect).

Referring to FIG. 4, the hidden menu buttons are arranged such that a central button 38 is selected by default (which would remain selected if no input is received from either handset), other menu buttons being selected according to the signal(s) subsequently received from the handsets (if any) and the order in which those signals are received.

Thus, using the previous example, wherein navigate “up” and navigate “left” signals are required from respective handsets to select the correct answer to a particular question, it can be seen that button 40 will be selected if both players are correct but an “up” signal is received from the first handset before a “left” signal is received from the second handset, but button 42 will instead be selected if the same signals are received in the opposite order.

The disc embodying the menu of FIG. 4 may be authored so that upon a pre-set time-out of the menu, the value stored in register SPRM8 of the DVD player is used to determine whether each player's respective score is to be incremented or decremented and to what extent.

The disc may also be authored such that the menu time-out is overridden if 2 distinct inputs are received, i.e. by associating an appropriate menu-exiting command with each of the buttons 40-54, which is invoked immediately upon that button being selected.

It will be appreciated that, in most circumstances, it will not be important to know the order in which 2 signals are received, if one or both of those signals correspond to an incorrect answer, and that, in such circumstances, the menu need only comprise a sufficient number of menu buttons (linked appropriately) to determine which of 2 players answering a question correctly is the first to transmit the corresponding signal from his or her respective handset, e.g. in the present example, buttons pairs 44 and 46, 48 and 50 and 52 and 54 could each be combined into a single respective button.

Referring to FIG. 5, the hidden menu buttons are instead arranged such that a left-hand button 56 is selected by default (which would remain selected if no input is received from either handset), other menu buttons being selected according to the signal(s) received from the handsets (if any) and the order in which those signals are received.

In this arrangement, each of buttons 58, 60, 62 and 64 has respective commands associated with it which are executed immediately upon the selection of that button, to cause an appropriate register to be incremented by an appropriate value and a further, pre-determined button to be selected e.g. a command of the form GPRMx+=1, LinkNoLink (button y).

Take, for example, the case where a first player is assigned general purpose register GPRM1 and the second player GPRM2, it can be seen that if the handset of player 1 is the first to provide a signal representing a correct answer (once again, an “up” signal), then GPRM1 will immediately be incremented by 2 and button 66 selected. If player 2 then provides a signal representing a correct answer (a “left” signal), GPRM2 is immediately incremented by 1 and button 68 selected. The menu may be arranged to time-out, after a pre-determined period of time, if button 68 is not selected (a menu-exiting command associated with button 68 being immediately invoked upon that value being selected), the values stored in registers GPR1 and GPRM2, at any one time, providing a clear indication of the correctness and order in which signals have been received.

Whilst embodiments of the present invention have been described with reference to a quiz game, wherein players are required to answer or identify the correct answer to questions presented visually, it would remain in accordance with the invention for questions to instead be presented audibly or for players to be required to distinguish between different audio clips or visual images presented to them.

The apparatus thus described may be used to provide a variety of hitherto unrealisable, interactive multi-player games.

1-49. (canceled)

50. A game-playing apparatus, comprising:
a DVD player for playing an optical data-storage disc;
an optical data-storage disc authored to provide an interactive game; and,
at least two handsets for remotely controlling the operation of the playing device to play the game, wherein each handset is reconfigurable to associate a different control signal, or sequence of control signals, with a control button of the first handset than the control signal, or sequence of control signals, associated with the same operating button of the second handset.

51. The game playing apparatus according to claim 50, wherein said control signals comprise infra-red control signals.

52. The game-playing apparatus according to claim 51, wherein each of said at least two handsets comprises an infra-red receiver and is arranged to be reconfigured by receiving, via said infra-red receiver, the control signal to be associated with said at least on operating button, from another handset.

53. The game-playing apparatus according to claim 50, wherein the disc is authored such that game-players are identified from the control signals associated with the buttons of their respective handsets.

54. The game-playing apparatus according to claim 53, wherein the disc is authored such that a plurality of game-players are each prompted for a response, the first person thereafter to press a particular button on his or her handset being identified.

55. The game-playing apparatus according to claim 53, wherein the disc is authored such that a plurality of game-players are each prompted for one a plurality of possible responses, each corresponding to a different button on each of the game-players' handsets, the first or each game-player to provide a required response (by pressing the appropriate button on his or her handset) being identified.

56. The game-playing apparatus according to claim 50, wherein said at least two handsets are configured such that different menu-navigation buttons are mimicked by corresponding buttons of those handsets, the optical data-storage disc being authored such that players are presented with a menu having respective on-screen menu-buttons arranged to be selected by the pressing of each of said corresponding handset buttons, and such that a respective action associated with each of the menu-buttons is automatically invoked.

57. The game-playing apparatus according to claim 56, wherein the action associated with each of the menu-buttons is to modify the value(s) stored in one or more registers.

58. The game-playing apparatus according to claim 56, wherein the action associated with each of the menu-buttons is to display a further menu.

59. The game-playing apparatus according to claim 56, wherein the menu-buttons are hidden.

60. A method for configuring an apparatus for use in playing a game, comprising the steps of:
providing an optical data-storage disc authored to provide an interactive game;
providing a DVD player for playing the optical data-storage disc;
providing substantially identical first and second remote control handsets, each handset being reconfigurable to associate a desired control signal (or sequence of control signals) with at least one operating button thereof; and,
configuring the first and second handsets such that a different control signal (or sequence of control signals) is associated with a control button of the first handset than that, or those, associated with the same operating button of the second handset.

61. A game-playing apparatus comprising a DVD player for playing an optical data-storage disc, an optical data-storage disc authored to provide an interactive game and at least two handsets for remotely controlling the operation of the playing device to play the game, wherein different control signals are associated with corresponding buttons of those handsets and the optical data-storage disc is authored such that players are presented with a menu having respective on-screen menu-buttons arranged to be selected by the pressing of each of said corresponding handset buttons, and such that a respective action associated with each of the menu-buttons is automatically invoked.

62. The game playing apparatus according to claim 61, wherein said control signals comprise infra-red control signals.

63. The game-playing apparatus according to claim 62, wherein each of said at least two handsets comprises an infra-red receiver and is arranged to be reconfigured by receiving, via said infra-red receiver, the control signal to be associated with said at least on operating button, from another handset.

64. The game-playing apparatus according to claim 61, wherein the disc is authored such that game-players are identified from the control signals associated with the buttons of their respective handsets.

65. The game-playing apparatus according to claim 64, wherein the disc is authored such that a plurality of game-players are each prompted for a response, the first person thereafter to press a particular button on his or her handset being identified.

66. The game-playing apparatus according to claim 64, wherein the disc is authored such that a plurality of game-players are each prompted for one a plurality of possible responses, each corresponding to a different button on each of the game-players' handsets, the first or each game-player to provide a required response (by pressing the appropriate button on his or her handset) being identified.

67. The game-playing apparatus according to claim 61, wherein the action associated with each of the menu-buttons is to modify the value(s) stored in one or more registers.

68. The game-playing apparatus according to claim 61, wherein the action associated with each of the menu-buttons is to display a further menu.

69. The game-playing apparatus according to claim 61, wherein the menu-buttons are hidden.
